(19) United States
(12) Patent Application Publication
(10) Pub. No.: US 2018/0266187 A1
(43) Pub. Date: Sep. 20, 2018

(54) THERMAL RESISTANT WELL CASING

(71) Applicant: Tim Youngquist, Fort Myers, FL (US)

(72) Inventor: Tim Youngquist, Fort Myers, FL (US)

(21) Appl. No.: 15/460,833

(22) Filed: Mar. 16, 2017

(51) Int. Cl. E21B 17/00; E21B 43/12; F16L 9/12

(52) U.S. Cl. CPC E21B 17/00; F16L 9/12; E21B 43/121

(57) ABSTRACT

An industrial water well with heat resistant well casing. A thermally resistant well casing is provided within the well bore at a depth where a submersible pump is carried within the casing. The thermally resistant pipe will not be damaged by the heat generated by a failing or failed submersible pump, permitting the pump to be extracted and repaired/replaced before collapse of the casing.

### BACKGROUND OF THE INVENTION

The present invention relates to water wells and, more particularly, well casings around submersible water pumps.

Submersible pumps are commonly used in a water wells to pump water from the base of the well to the surface for distribution and delivery of the water. There are several causes for the pump to heat up, which can damage the PVC well casing or tubing that are typically employed for water well. Such causes include control systems failing to shut the pump off once the preset pressure is reached, the lowering of the existing water table over time, and cavitation of the pump. Each of these among the most common causes of pump failure, which causes heat buildup within the well casing.

The heat causes the PVC well casing to loose its integrity, which may cause the casing to collapse around the submersible pump. This makes it impossible to remove and repair the pump. If the heat build up damages the well casing, the well must be plugged and abandoned and drilling a new well is required.

As can be seen, there is a need for an improved well casing that can maintain its integrity in the event of pump failure and consequent heating.

### SUMMARY OF THE INVENTION

In one aspect of the present invention, a water well includes a well bore having a depth corresponding to a targeted subterranean water source, One or more well casing segments are carried within the well bore to a depth corresponding to the targeted subterranean water source. The one or more well casing segments includes at least one thermally protective well casing segment positioned within the well bore at a desired depth for a submersible pump that configured to convey water from the subterranean water source to a top end of the bore. The water well preferably includes a well pump positioned within the thermally protective well casing segment. A production tube operatively connects to an outlet of the well pump and in communication with a water delivery outlet proximal to the top end of the bore. In some embodiments, the one or more well casing segments are formed of polyvinyl chloride (PVC) pipe. In preferred embodiments, the at least one thermally protective well casing segment is formed of fiberglass reinforced pipe (FRP). A coupling is configured to join the PVC pipe and the FRP.

Other aspects of the invention include a method of preparing a water well. The method includes determining a depth for positioning a submersible pump within a targeted subterranean water source; drilling a well bore extending into the targeted subterranean water source and inserting a well casing within the well bore; and positioning a thermally protective well casing at the determined pump depth. The method may also include positioning the submersible pump within the thermally protective well casing and installing a delivery tube between a submersible pump outlet and a water delivery outlet proximal to a top end of the well bore. In preferred embodiments, the method includes operating the submersible pump to convey water from the targeted subterranean water source to the water delivery outlet. The method may also include removing the submersible pump from the well bore. The submersible pump may then be replaced within the well bore and positioned within the thermally protective casing.

These and other features, aspects and advantages of the present invention will become better understood with reference to the following drawings, description and claims.

### BRIEF DESCRIPTION OF THE DRAWINGS

FIG. 1 is a cross sectional diagram of a well bore and thermally protective casing according to aspects of the invention.

FIG. 2 is a flow chart for a method of forming a water well.

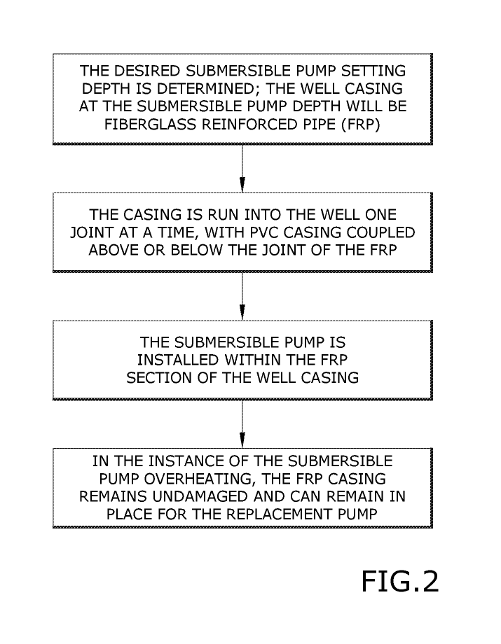

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a thermally resistant well casing and method to prevent the deleterious effects of pump failure and consequent heating on the integrity of the well casing. The system and method are amenable to industrial and municipal water wells where a well pump is positioned within a well casing of a well bore.

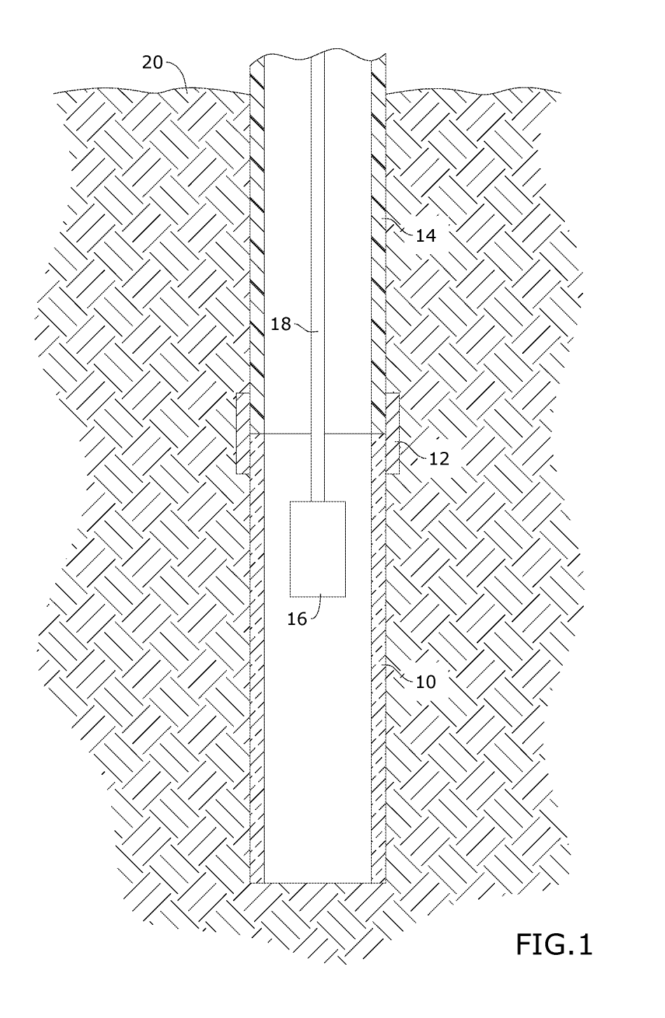

As seen in reference to FIG. 1, a typical well bore according to aspects of the invention is illustrated. The well bore is formed in the surface of the ground 20 to a desired depth to extend to a desired water subterranean water source. A base of the bore includes a thermally resistant well casing segment 10. The thermally resistant well casing segment 10 may be formed as a pipe of thermally resistant material and is preferably a fiberglass reinforced pipe segment. The thermally resistant well casing segment 10 may be joined to one of a plurality of conventional PVC well casing segments 14 via a coupling 12, configured to join the two dissimilar materials.

A submersible pump 16 is carried by a production tube 18 and is positioned within an interior cavity of the thermally resistant casing 10. The production tube 18 carries the water that is pumped through an outlet of the submersible pump 16 to a water delivery outlet proximal the ground surface 20, where the water may be treated, and/or conveyed to a water treatment facility. The coupling 12 can be installed at any depth in the well. However for the well casing to be protected from heat generated by the submersible pump 16 the pump 16 must be set at a depth within the thermally resistant casing segment 10. The pump 16 need only be positioned at a level within the bore where the water table is sufficient to maintain the pump 16 submerged in the water. Accordingly, additional segments 14 may be positioned below the thermally resistant segment 10 when the pump 16 is positioned above the base of the bore.

A method according to aspects of the present invention includes, determining a depth of a well bore for the placement of a submersible pump 16 for the delivery of water from the well bore depth. Next, the casing is extended into the well bore, one segment at a time, and a thermally resistant well casing segment 10 is positioned at the determined depth for the submersible pump. The thermally resistant casing 10 is joined to one or more conventional well casing segments 14, which may be positioned above and/or below the determined position. Once the well casing segments 10, 14 have been installed, the submersible pump 16 is positioned within the thermally resistant casing 10 and is coupled to the production tube 18. The pump 16 may be operated to deliver water from the well bore to a water treatment facility. In the event of a failure of the pump 16, the well casing may be opened and the pump 16 may be withdrawn from the bore for servicing or replacement.

It should be understood, of course, that the foregoing relates to exemplary embodiments of the invention and that modifications may be made without departing from the spirit and scope of the invention as set forth in the following claims.

What is claimed is:

1. A water well, comprising:
a well bore having a depth corresponding to a targeted subterranean water source;
one or more well casing segments carried within the well bore to a depth corresponding to the targeted subterranean water source, wherein the one or more well casing segments includes at least one thermally protective well casing segment positioned within the well bore at a desired depth for a submersible pump configured to convey water from the subterranean water source to a top end of the bore.

2. The water well of claim 1, further comprising:
a well pump positioned within the thermally protective well casing segment.

3. The water well of claim 2, further comprising:
a production tube operatively connected to an outlet of the well pump and in communication with a water delivery outlet proximal to the top end of the bore.

4. The water well of claim 1, wherein the one or more well casing segments are formed of polyvinyl chloride (PVC) pipe.

5. The water well of claim 4, wherein the at least one thermally protective well casing segment is formed of fiberglass reinforced pipe (FRP).

6. The water well of claim 5, further comprising:
a coupling configured to join the PVC pipe and the FRP.

7. A method of preparing a water well, comprising:
determining a depth for positioning a submersible pump within a targeted subterranean water source;
drilling a well bore extending into the targeted subterranean water source and inserting a well casing within the well bore;
positioning a thermally protective well casing at the determined pump depth.

8. The method of claim 7, further comprising:
positioning the submersible pump within the thermally protective well casing.

9. The method of claim 8, further comprising:
installing a delivery tube between a submersible pump outlet and a water delivery outlet proximal to a top end of the well bore.

10. The method of claim 9, further comprising:
operating the submersible pump to convey water from the targeted subterranean water source to the water delivery outlet.

11. The method of claim 9, further comprising:
removing the submersible pump from the well bore.

12. The method of claim 11, further comprising:
replacing the submersible pump within the well bore and positioning the submersible pump within the thermally protective casing.
